(19) United States
(12) Patent Application Publication
(10) Pub. No.: US 2009/0316017 A1
(43) Pub. Date: Dec. 24, 2009

(54) IMAGING APPARATUS, DATA COMMUNICATING SYSTEM, AND DATA COMMUNICATING METHOD

(75) Inventors: Nobuhiko ICHII, Hirakata-shi (JP); Hiroshi YAMAGA, Nara-shi (JP); Yurie SAKAI, Osaka-shi (JP)

Correspondence Address: NOVAK DRUCE DELUCA + QUIGG LLP, 1300 EYE STREET NW, SUITE 1000 WEST TOWER, WASHINGTON, DC, 20005, US

(73) Assignee: SANYO ELECTRIC CO., LTD., Osaka (JP)

(21) Appl. No.: 12/487,482

(22) Filed: Jun. 18, 2009

(30) Foreign Application Priority Data
Jun. 19, 2008 (JP) 2008-160945

(51) Int. Cl. H04N 5/228

(52) U.S. Cl. 348/222.1; 348/E05.022

(57) ABSTRACT

An imaging apparatus is so configured that the imaging apparatus and an external electronic device are connected, and when the imaging apparatus is in a power-save mode state, if a predetermined button on an external electronic device-use remote controller is depressed, the imaging apparatus is shifted from the power-save mode to a normal activation mode, and respective thumbnail images of a still image file and/or a moving image file stored in the imaging apparatus are multi-displayed on the external electronic device. Therefore, a user is able to immediately confirm what images are stored in the imaging apparatus with a simple manipulation, and thus, convenience is provided.

### CROSS REFERENCE OF RELATED APPLICATION

The disclosure of Japanese Patent Application No. 2008-160945, which was filed on Jun. 19, 2008 is incorporated herein by reference.

### BACKGROUND OF THE INVENTION

1. Field of the Invention

The present invention relates to an imaging apparatus, a data communicating system, and a data communicating method. In particular, the present invention relates to an imaging apparatus, having a storing function of storing a still image and/or a moving image and an interface for connecting an external device, in which reduced images of the still image and/or the moving image are outputted and multi-displayed, for example.

2. Description of the Related Art

In the recent years, there is commercialized a video camera having a function capable of not only imaging and recording a still image but also imaging and recording a moving image over a long period of time. It is possible not only to reproduce and display the photographed moving image on a monitor provided in the video camera but also to reproduce and display the image by a television receiver connected to the video camera. The television receiver is of a fixed-pixel system represented by a liquid crystal display, a cathode ray tube system, or a similar system. There is commercialized a video camera or a television receiver having an interface of an HDMI (High-Definition Multimedia Interface) standard as a connection interface between the video camera and the television receiver for realizing this reproduction display. Between the connected video camera and television receiver, having the HDMI-standard interface, it is possible to transmit and receive data, such as a video signal, an audio signal, and a control signal, by a single cable.

By the way, among products that comply with the HDMI standard, there is a product provided with a mutual-device controlling function that is called a CEC (Consumer Electronics Control). When this CEC function is used, a user becomes able to control a plurality of electronic devices having the CEC function by a single remote controller.

According to one example of this type of electronic device, when an output source of a display device is switched between a display device side and a game machine side, it is not necessary to switch between a manipulation-use remote controller and a game controller and it is not necessary, either, to intentionally orient a direction of the remote controller or the game controller to a direction different from a screen. Thus, it is possible to obtain good operability.

However, when no data communication is performed between the video camera and the television receiver while these two components are connected, for example, the video camera is usually activated with the minimum required power. When the user wishes to immediately know what images are stored in the video camera in this sate, it is necessary to perform complicated manipulations such as starting the video camera by manually manipulating a power supply switch of the video camera or starting the video camera by an accompanying remote controller and also performing a multi screen display manipulation after setting a current mode to a reproduction mode.

### SUMMARY OF THE INVENTION

An imaging apparatus according to the present invention, comprises: an imager for fetching an optical image of a subject so as to produce an image signal; an interface portion for connecting an external electronic device controlled according to an instruction from a remote controller including a manipulation key and a main body of the imaging apparatus; a command acceptor for accepting a command that is outputted from the external electronic device and that corresponds to an instruction in response to each manipulation of the manipulation key of the remote controller; a reduced image signal producer for producing a reduced image signal corresponding to a reduced image of a still image or a moving image corresponding to the image signal, based on the image signal; a storer for storing the image signal as an image file; an output controller for executing an output process for outputting a plurality of the reduced image signals corresponding to a plurality of the image files stored in the storer, to the external electronic device via the interface portion; and a controller for shifting one portion of the main body of the imaging apparatus to an activation state so as to execute the output process in the output controller, when a command corresponding to an instruction in response to a single manipulation of the manipulation key is accepted in the command acceptor in a case where the one portion of the main body of the imaging apparatus at least including the imager and the output controller is in a non-activation state.

Preferably, the interface portion complies with an HDMI standard, and is provided with a mutual-device controlling function.

Preferably, the external electronic device further comprises a displayer, the reduced image signal outputted by the output controller is a digital signal, and the digital signal outputted via the interface portion is supplied to the displayer.

According to the present invention, a data communicating system for performing a data communication with an external electronic device that is connected to an imaging apparatus and that is controlled according to an instruction from a remote controller provided with a manipulation key, the imaging apparatus, comprises: an imager for fetching an optical image of a subject so as to produce an image signal; a reduced image signal producer for producing a reduced image signal corresponding to a reduced image of a still image or a moving image corresponding to the image signal, based on the image signal; and a storer for storing the image signal as an image file, and the data communicating system, further comprises: a command acceptor for accepting a command that is outputted from the external electronic device and that corresponds to an instruction in response to each manipulation of the manipulation key of the remote controller; an output controller for executing an output process for outputting a plurality of the reduced image signals corresponding to a plurality of the image files stored in the storer, to the external electronic device; and a controller for shifting one portion of the main body of the imaging apparatus to an activation state so as to execute the output process in the output controller, when a command corresponding to an instruction in response to a single manipulation of the manipulation key is accepted in the command acceptor in a case where the one portion of the main body of the imaging apparatus at least including the imager and the output controller is in a non-activation state.

According to the present invention, a data communicating method for performing a data communication with an external electronic device that is connected to an imaging apparatus and that is controlled according to an instruction from a remote controller provided with a manipulation key, the imaging apparatus, including: an imager for fetching an optical image of a subject so as to produce an image signal; a reduced image signal producer for producing a reduced image signal corresponding to a reduced image of a still image or a moving image corresponding to the image signal, based on the image signal; a storer for storing the image signal as an image file; and an output controller for executing an output process for outputting via a plurality of the reduced image signals corresponding to a plurality of the image files stored in the storer, to the external electronic device, the data communicating method, comprises: a command accepting step of accepting a command that is outputted from the external electronic device and that corresponds to an instruction in response to each manipulation of the manipulation key of the remote controller; a shifting step of shifting one portion of the main body of the imaging apparatus to an activation state so as to execute the output process in the output controller, when a command corresponding to the instruction in response to a single manipulation of the manipulation key is accepted in the command accepting step in a case where the one portion of the main body of the imaging apparatus at least including the imager and the output controller is in a non-activation state; and a step for executing an output process in the output controller after the shifting step.

The above described features and advantages of the present invention will become more apparent from the following detailed description of this embodiment when taken in conjunction with the accompanying drawings.

### BRIEF DESCRIPTION OF THE DRAWINGS

FIG. 1 is a diagram showing an example of connecting an electronic camera, which is one embodiment of the present invention, and a television receiver, which is an external electronic device;

FIG. 2 is a diagram showing an array of buttons of a television receiver-use remote controller, which is an external electronic device, connected to the electronic camera, which is one embodiment of the present invention;

FIG. 3 is a block diagram showing a configuration of the electronic camera which is one embodiment of the present invention;

FIG. 4 is a diagram showing an array of connector pins of an HDMI terminal of the electronic camera which is one embodiment of the present invention;

FIG. 5 is an illustrative view showing one example of a multi display of nine thumbnail images displayed on an LCD monitor of the electronic camera which is one embodiment of the present invention, or on a display of the television receiver, which is an external electronic device, connected to the electronic camera;

FIG. 6 is a flowchart showing one portion of an operation of the electronic camera which is one embodiment of the present invention; and

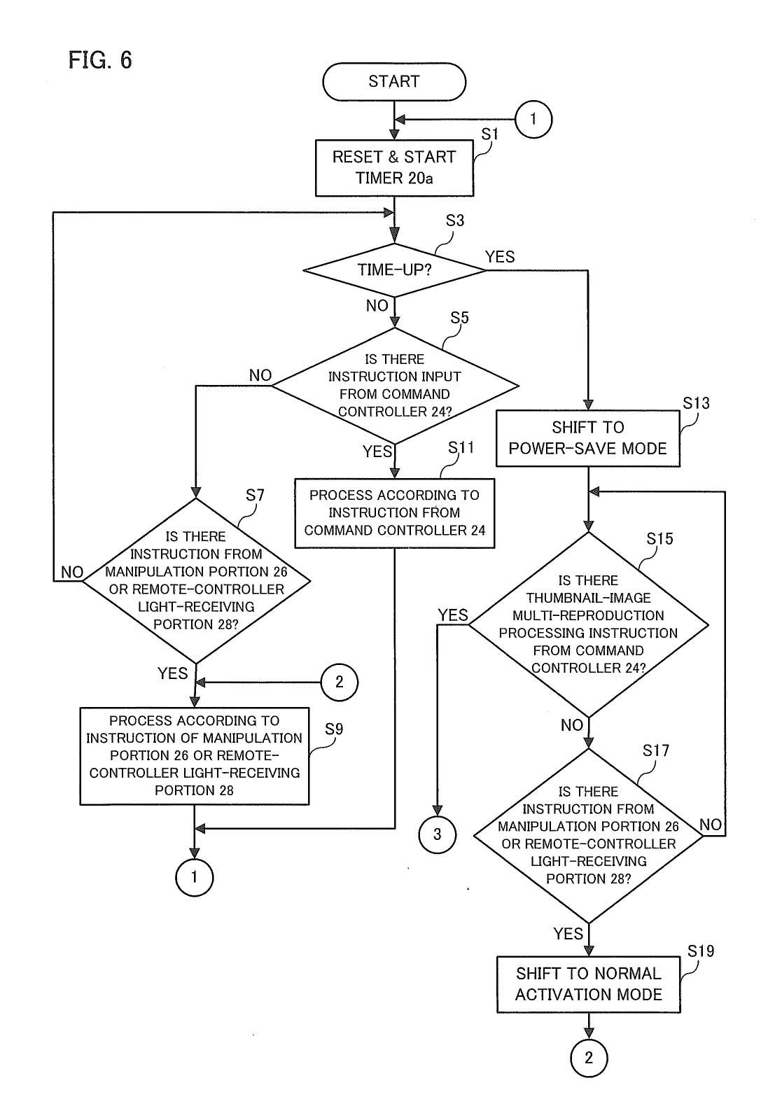

FIG. 7 is a flowchart showing another portion of the operation of the electronic camera which is one embodiment of the present invention.

### DETAILED DESCRIPTION OF THE PREFERRED EMBODIMENTS

In this embodiment, as one example of an imaging apparatus, a mode of an electronic camera 10 is described.

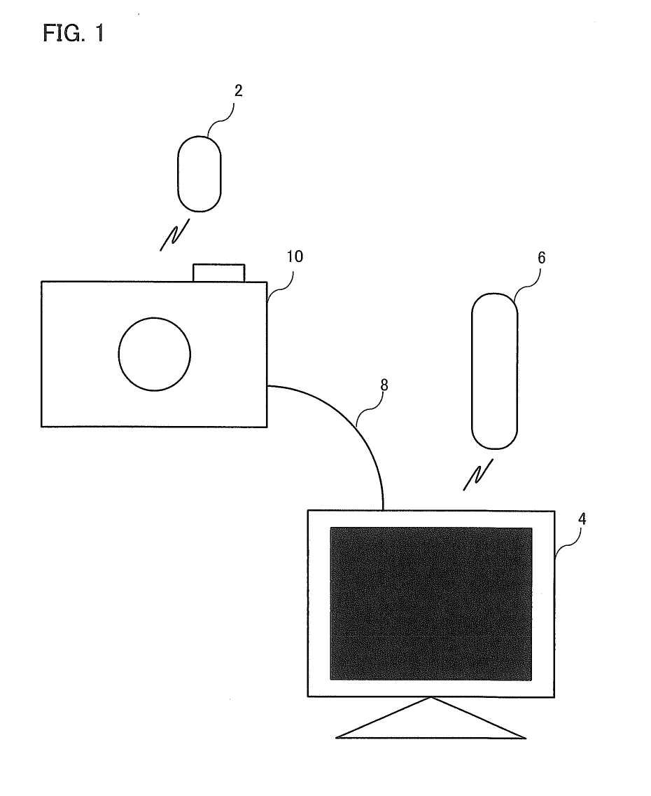

FIG. 1 shows an example of connecting the electronic camera 10 of this embodiment to a television receiver 4. The electronic camera 10 and the television receiver 4 are connected through an HDMI cable 8. Reference numeral 2 denotes an electronic camera-use remote controller for applying a manipulation instruction to the electronic camera 10. Reference numeral 6 denotes a television receiver-use remote controller for applying a manipulation instruction to the electronic camera 10 connected to the television receiver 4 through the HDMI cable 8.

Then, the electronic camera 10 and the television receiver 4 transmit and receive data according to an HDMI standard. Hereinafter, the description is based on a configuration that the electronic camera 10 of this embodiment is connected to the television receiver 4 through the HDMI cable 8, and transmits and receives data according to the HDMI standard.

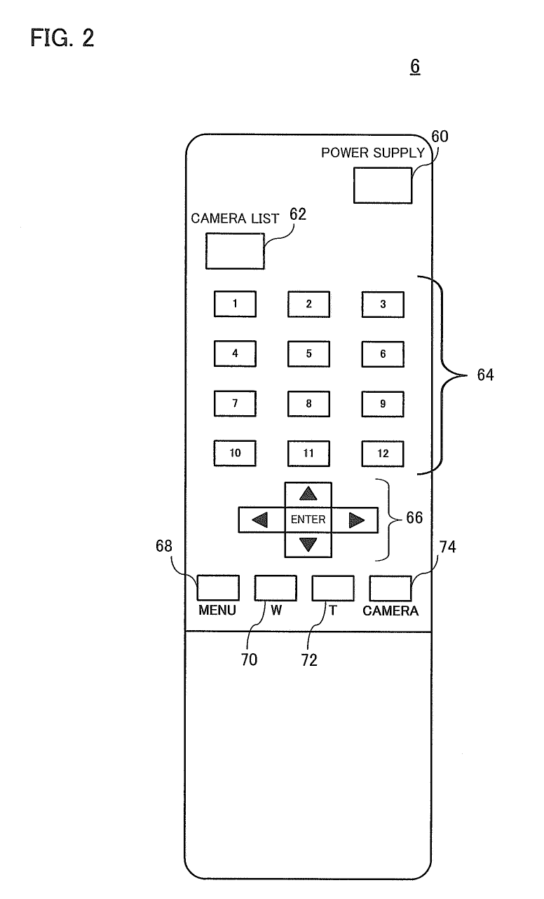

FIG. 2 is a diagram showing a placement of buttons in the television receiver-use remote controller 6. Reference numeral 60 denotes a power supply button for supplying power to the television receiver 4. Reference numeral 62 denotes a camera list button. If the camera list button 62 is depressed, in a state where the electronic camera 10 and the television receiver 4 are connected through the HDMI cable 8 and when the electronic camera 10 is in a power-save mode in which power is saved, the following is caused: the electronic camera 10 is shifted from the power-save mode to a normal activation mode in which the electronic camera 10 is normally activated, and a list of image information stored in the electronic camera 10, to be more detailed, a thumbnail-image multi-display screen, is outputted to the television receiver 4. The power-save mode is described in detail later. Reference numeral 64 denotes a channel selecting button for selecting channels of the television receiver 4, and reference numeral 66 denotes a cursor key for selecting/determining various items displayed on the television receiver 4. Herein, a state in which the electronic camera 10 and the television receiver 4 are connected through the HDMI cable 8 is defined as an HDMI connection state. Reference numeral 68 denotes a menu button so configured that when it is depressed in the HDMI connection state, a menu screen of the electronic camera 10 is outputted to the television receiver 4, and reference numeral 70 denotes a WIDE button so configured that when it is depressed in the HDMI connection state, a wide angle process is performed on image data within the electronic camera 10 and the processed image data is outputted to the television receiver 4. Reference numeral 72 denotes a TELE button so configured that when it is similarly depressed in the HDMI connection state, a zoom process is performed on the image data within the electronic camera 10, and the processed data is outputted to the television receiver 4, and reference numeral 74 denotes a camera button so configured that when it is depressed in the HDMI connection state, the electronic camera 10 is caused to perform a still-image shooting process described later, and the resultant image is outputted to the television receiver 4.

Thus, the electronic camera 10 and the television receiver 4 that are connected with the HDMI cable 8 to each other are provided with a mutual-device controlling function called CEC according to the HDMI standard, and by using this CEC function, operations of the electronic camera 10 are realized through a manipulation of the television receiver-use remote controller 6.

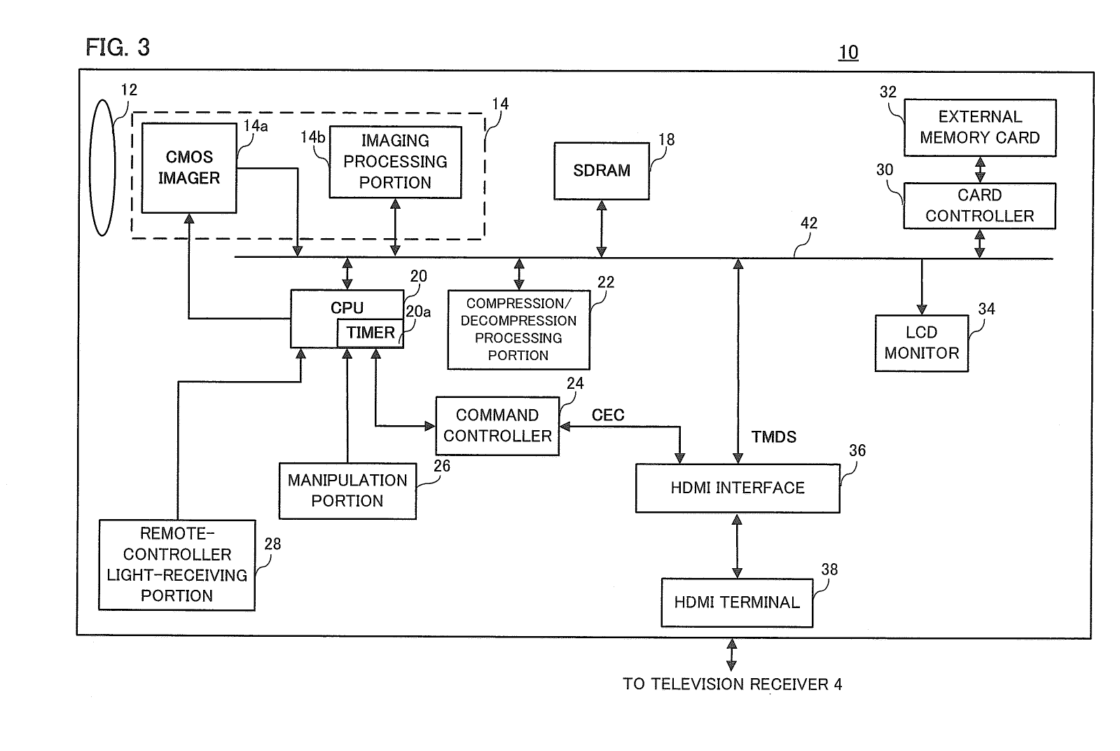

Next, the electronic camera 10 is described in detail by using FIG. 3, which is a block diagram of an interior of the electronic camera 10 show in FIG. 1.

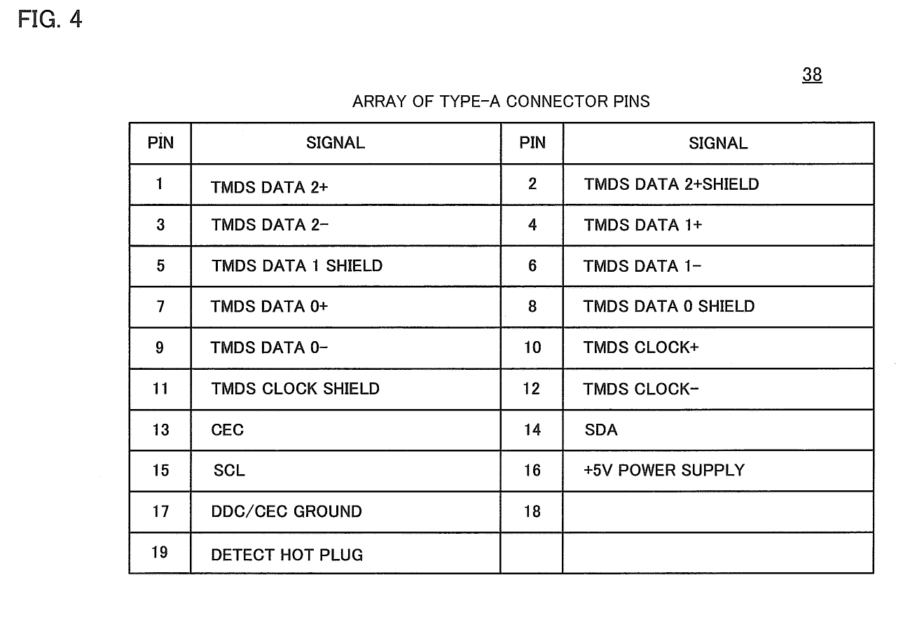

The electronic camera 10 is configured to include: an imaging lens 12; a CMOS imager unit 14 having a CMOS imager 14a and an imaging processing portion 14b; an SDRAM 18; a CPU 20 having a timer 20a; a compression/decompression processing portion 22; a command controlling portion 24; a manipulating portion 26; a remote controller light-receiving portion 28; a card controlling portion 30; an external memory card 32; an LCD monitor 34; an HDMI interface 36; an HDMI terminal 38; and a bus 42. FIG. 4 shows a connector pin array of the HDMI terminal 38. Transmitting and receiving data to and from the television receiver 4 is performed via the HDMI terminal 38.

The imaging lens 12 forms an optical image of a subject on an imaging surface of the CMOS imager 14a, which is an imaging device. Furthermore, the imaging lens 12 is adjusted in movement in an optical axis direction based on an output signal of the CMOS imager 14a. An analog imaging signal outputted from the CMOS imager 14a is once accommodated in the SDRAM 18, the analog imaging signal accommodated in the SDRAM 18 is inputted to the imaging processing portion 14b, and various signal processes are performed thereon by the imaging processing portion 14b. As a result, a Y signal that is a luminance signal, and U and V signals that are color-difference signals are produced.

The imaging lens 12, the CMOS imager unit 14, the SDRAM 18, the compression/decompression processing portion 24, the card controlling portion 30, and the LCD monitor 34 are controlled by the CPU 20 via the bus 42. The CPU 20 controls connected blocks according to a program accommodated in an internal memory not shown. Furthermore, the timer 20a is arranged inside the CPU 20 and counts a time period. When a predetermined time period is counted, the timer 20a sets a flag indicating a time-up state.

The CPU 20 is also connected to the command controlling portion 24, the manipulating portion 26, and the remote controller light-receiving portion 28. Then, in the electronic camera 10, there is arranged the power-save mode that is shifted from the normal activation mode in which the electronic camera 10 is normally activated to a mode in which one portion of activation is stopped when the CPU 20 determines, by detecting the flag indicating the time-up state from the timer 20a, that there is no input of the manipulation instruction to the manipulating portion 12 or to the remote control light-receiving portion 28 within a predetermined time period.

During the power-save mode of this embodiment, although power is supplied to the HDMI interface 36, the command controlling portion 24, and the CPU 20, no power is supplied to the other blocks, and thus, the other blocks are in a non-activation state. When the power is supplied to almost all the blocks during this non-activation state, these blocks are changed to a normal activation state, and this state is defined as a normal activation mode.

Upon receiving instructions from the manipulating portion 26, the remote controller light-receiving portion 28, or the command controlling portion 24, the CPU 20 executes an imaging process and a reproducing process. In the electronic camera 10 of this embodiment, the imaging process is composed of a still-image shooting process and a moving-image shooting process.

Firstly, the still-image shooting process is specifically described. When a still-image shooting instruction is applied to the CPU 20 from the manipulating portion 26 or the remote controller light-receiving portion 28 or the command controlling portion 24, the CPU 20 produces one frame of Y, U, and V signals by controlling the imaging lens 12, the CMOS imager unit 14, and the SDRAM 18. The Y, U, and V signals are again accommodated temporarily in the SDRAM 18 via the bus 42, and then, inputted to the compression/decompression processing portion 22. In the compression/decompression processing portion 22, a compressing/decompressing process is performed on the Y, U, and V signals. When the still-image shooting process is executed, the compression/decompression processing portion 22 performs the compressing/decompressing process on the Y, U, and V signals according to a JPEG format, as the compressing/decompressing process, and outputs still-image compressed data to the bus 42.

Furthermore, a thinning-out process is performed by the CPU 20 on the Y, U, and V signals temporarily accommodated in the SDRAM 18, and still-image thumbnail image data is produced. This data is then inputted to the compression/decompression processing portion 22, and a compressing process is performed on the inputted data by a JPEG format. As a result, still-image thumbnail compressed data is produced, and outputted to the bus 42. The outputted still-image compressed data and still-image thumbnail compressed data are stored on the external memory card 32 as a still-image file by the card controlling portion 30 controlled by the CPU 20.

Subsequently, the moving-image shooting process is specifically described. When a moving-image shooting instruction is applied to the CPU 20 from the manipulating portion 26 or the remote controller light-receiving portion 28 or the command controlling portion 24, the CPU 20 controls the imaging lens 12, the CMOS imager unit 14, and the SDRAM 18 so as to repeatedly produce the Y, U, and V signals at a predetermined frame rate. The Y, U, and V signals are again accommodated in the SDRAM 18 via the bus 42, and are repeatedly inputted into the compression/decompression processing portion 22. When the moving-image shooting process is executed, the compression/decompression processing portion 22 performs a compressing process on the Y, U, and V signals according to an MPEG format as a compressing process, and moving-image compressed data is accommodated in the SDRAM 18 via the bus 42. Furthermore, the CPU 20 performs a thinning-out process on one frame of the Y, U, and V signals accommodated continuously in the SDRAM 18 so as to produce a moving-image thumbnail image. Then, the moving-image thumbnail image is inputted to the compression/decompression processing portion 22 (in this case, the compression/decompression processing portion 22 performs a compressing process according to a JPEG format), and as a result, moving-image thumbnail compressed image data is produced. Moreover, the moving-image compressed data and the moving-image thumbnail image are stored, as a moving image file, on the external memory card 32 by the card controlling portion 30 controlled by the CPU 20.

Subsequently, the reproducing process is specifically described. In this embodiment, the reproducing process includes: a thumbnail-image multi reproducing process in which thumbnail-image multi-display-screen data composed of still-image thumbnail images or moving-image thumbnail images of a plurality of still image files or moving image file is produced, and the produced data is outputted to the television receiver 4 via the LCD monitor 34 or the HDMI interface 36; a still-image reproducing process in which one frame of a still image of a still image file is outputted to the television receiver 4 via the LCD monitor 34 or the HDMI interface 36; and a moving-image reproducing process in which a moving image configured by a plurality of frames of a moving image file is outputted to the television receiver 4 via the LCD monitor 34 or the HDMI interface 36 at a frame rate during imaging.

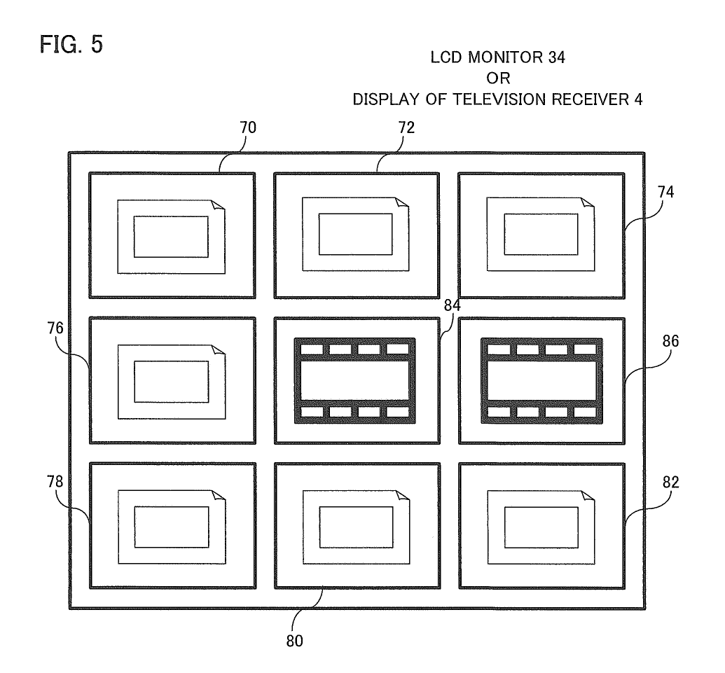

Firstly, the thumbnail-image multi reproducing process is specifically described. When a thumbnail-image multi-reproduction-processing instruction for outputting from the manipulating portion 26 or the remote controller light-receiving portion 28 to the LCD monitor 34 is applied to the CPU 20, the CPU 20 controls the card controlling portion 30 so as to read out the thumbnail images of each file from the still image files and moving image files stored on the external memory card 32, and then outputs the read-out images to the compression/decompression processing portion 22. In the compression/decompression processing portion 22, a decompressing process is performed according to a JPEG format, and the resultant image is outputted to SDRAM 18. Then, the CPU 20 produces the thumbnail-image multi-display-screen data in which a thumbnail including a total of nine thumbnail images, i.e., vertical 3 images×horizontal 3 images, is arrayed on the SDRAM 18, and outputs this data to the LCD monitor 34. As shown in FIG. 5, the thumbnail-image multi display screen of this embodiment is composed of: seven still-image thumbnail images, corresponding to the still-image file, shown in 70 to 82; and two moving-image thumbnail images, corresponding to the moving image file, shown in 84 and 86. In the thumbnail-image multi reproducing process, the thumbnail-image multi-display-screen data of these thumbnail images is produced.

Furthermore, when the camera list button 62 of the television receiver-use remote controller 6 is depressed in the above-described power-save mode, a thumbnail-image output command for instructing to output the thumbnail images of each file stored on the external memory card 32 is inputted to the command controlling portion 24. The thumbnail-image output command undergoes from the partially-activating HDMI interface 36 through the CEC signal line, via the HDMI terminal 38 connected to the television receiver 4.

The command controlling portion 24 performs a command analysis to analyze what type of command is inputted. Upon determining that the inputted command is a command for outputting the thumbnail-image multi-display-screen data to the television receiver 4, the command controlling portion 24 outputs the thumbnail-image multi-reproduction processing instruction for outputting the data to the television receiver 4, to the CPU 20.

Then, the CPU 20 shifts the electronic camera 10 from the power-save mode in which some activations are stopped, to the normal activation mode. Next, the CPU 20 reads out the thumbnail-image compressed data of each file from the still image file and/or the moving image file stored on the external memory card 32, and based on each thumbnail image data on which the decompressing process according to the JPEG format is performed by the compression/decompression processing portion 22, produces the thumbnail-image multi-display-screen data for arraying the nine thumbnails as shown in FIG. 5. Then, the thumbnail-image multi-display-screen data is outputted from the HDMI interface 36 via the HDMI terminal 38 to the television receiver 4 through a TMDS signal line.

Subsequently, the still-image reproducing process is specifically described. When the CPU 20 is applied a still-image reproduction processing instruction for outputting the still image of the still image file stored on the external memory card 32 to the LCD monitor 34 from the manipulating portion 26 or the remote controller light-receiving portion 28 to the LCD monitor 34, the CPU 20 controls the card controlling portion 30 so as to read out desired still-image compressed data, and then, inputs the read-out data into the compression/decompression processing portion 22. In the compression/decompression processing portion 22, the decompressing process is performed according to the JPEG format, and the processed data is once accommodated in the SDRAM 18, and then, the resultant data is outputted to the LCD monitor 34.

Furthermore, when a command for outputting the still image data that is based on the sfill-image compressed data stored on the external memory card 32 to the television receiver 4 is inputted to the command controlling portion 24 via the HDMI terminal 38 and the HDMI interface 36, as a result of the menu button 68 and the cursor key 66 on the television receiver-use remote controller 6 being manipulated, the command controlling portion 24 performs a command analysis to analyze what type of command is inputted.

Then, the command controlling portion 24 outputs to the CPU 20 an instruction for outputting the still image data to the television receiver 4. Upon receipt of the instruction, the CPU 20 controls the card controlling portion 30 so as to read out the desired still-image compressed data, performs the decompressing process according to the JPEG format in the compression/decompression processing portion 22, once accommodates the processed data in the SDRAM 18, and then, outputs the still image data to the television receiver 4 via the HDMI interface 36 and the HDMI terminal 38 through the TMDS signal line.

The moving-image reproducing process is executed by the CPU 20 with the substantially same procedure as that of the still-image reproducing process. A difference between the two processes includes that the decompressing process performed in the compression/decompression processing portion 22 is executed according to the MPEG system, and the moving image data is outputted to the LCD monitor 34 or to the television receiver 4 via the HDMI interface 36 and the HDMI terminal 38 at a frame rate during the moving-image shooting.

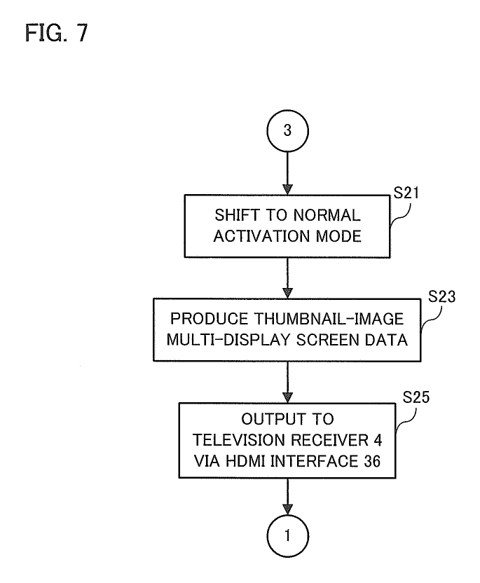

Subsequently, with reference to flowcharts shown in FIG. 7 and FIG. 8, the operation of the CPU 20 in the electronic camera 10 of this embodiment is described.

Firstly, when the power supply of the electronic camera 10 is turned ON, resetting and starting the timer 20a is executed in a step S1, and then the process proceeds to a step S3. In the step S3, the timer 20a times up, and it is determined whether or not the flag indicating a time-up state is set. When NO is determined in the step S3, the process proceeds to a step S5 in which it is determined whether or not there is instruction input from the command controlling portion 24. When NO is determined in the step S5, the process proceeds to a step S7 in which it is determined whether or not there is a manipulation instruction from the manipulating portion 26 or the remote controller light-receiving portion 28. When NO is determined, the process returns to the step S3. When YES is determined in the step S7, the process proceeds to a step S9 in which a process in response to the manipulation instruction from the manipulating portion 26 or the remote controller light-receiving portion 28 is executed. Then, the process returns to the step S1.

When YES is determined in the step S5, the process proceeds to a step S11 in which a process in response to the instruction from the command controlling portion 24 is executed. Then, the process returns to the step S1.

When YES is determined in the step S3, the process proceeds to a step S13 in which the electronic camera 10 is shifted from the normal activation mode to the power-save mode in which the activation in some blocks is stopped. Next the process proceeds to a step S15 in which it is determined whether or not there is the thumbnail-image multi reproduction processing instruction for outputting from the command controlling portion 24 to the television receiver 4. When NO is determined in the step S15, the process proceeds to a step S17 in which it is determined whether or not there is a manipulation instruction from the manipulating portion 26 or the remote controller light-receiving portion 28. When NO is determined in the step S17, the process returns to the step S15, and when YES is determined, the process proceeds to a step S19. In the step S19, the electronic camera 10 is shifted from the power-save mode in which some activations are stopped to the normal activation mode. Then, the process proceeds to the step S9.

When YES is determined in the step S15, the process proceeds to a step S21 in which the electronic camera 10 is shifted from the power-save mode in which some activations are stopped to the normal activation mode. Then, the process proceeds to a step S23. In the step S23, the thumbnail-image compressed data of each file is read out from the still image file and/or the moving image file stored on the external memory card 32, and then, based on each thumbnail image data on which the decompressing process according to the JPEG format is performed by the compression/decompression processing portion 22, the thumbnail-image multi-display-screen data for arraying the nine thumbnail images as shown in FIG. 5 is produced. Then, the process proceeds to a step S25 in which the thumbnail-image multi-display-screen data is outputted from the HDMI interface 36 via the HDMI terminal 38 to the television receiver 4 through the TMDS signal line. Then, the process returns to the step S1.

Thus, according to the embodiment, when the camera list button 62 of the television receiver-use remote controller 6 is depressed in a state where the electronic camera 10 and the television receiver 4 are connected through the HDMI cable 8 and the electronic camera 10 is in the power-save mode, the electronic camera 10 is shifted from the power-save mode to the normal activation mode, and each thumbnail image of the still image file and/or the moving image file stored on the external memory card 32 of the electronic camera 10 is multi-displayed on the television receiver 4. Therefore, this is convenient for the user because it is possible to immediately confirm what images are stored on the external memory card 20 with a simple manipulation.

Furthermore, the thumbnail images are multi-displayed on a display of the television receiver 4 that is larger than the LCD monitor 34 provided in the electronic camera 10, and thus, it becomes easier and more highly convenient than to search a desired thumbnail image on the LCD monitor 34.

Also, the electronic camera 10 and the television receiver 4 of this embodiment are connected through the HDMI cable 8 that complies with the HDMI-standard interface, and are able to transmit uncompressed digital audio and video. Thus, the image quality of the audio and video (that are high quality) is not deteriorated. This allows the user to view clear videos all the time. Furthermore, currently, electronic devices that are connected through the HDMI-standard interface to each other rapidly start to be widely used, and therefore, high versatility can be provided.

It is noted that in the electronic camera 10 of this embodiment, the CMOS imager 14a is adopted as an imaging device; it is also possible to adopt a CCD imager.

The electronic camera 10 of this embodiment is so configured that the still image file and/or the moving image file are stored on the external memory card 32. However, it is also possible that such files are stored in a memory arranged inside the electronic camera 10.

Also, in the electronic camera 10 of this embodiment, the HDMI-standard interface is adopted as an interface to be connected to the television receiver 4. However, another interface may also be adopted.

Further, the electronic camera 10 of this embodiment is configured to be directly connected to the television receiver 4 through the HDMI cable 8 via the HDMI terminal 38 within the electronic camera 10. However, between the electronic camera 10 and the television receiver 4, a cradle for the electronic camera 10 may be interposed to connect the both components.

In the electronic camera 10 of this embodiment, in the power-save mode state, the power is supplied only to the HDMI interface 36, the command controlling portion 24, and the CPU 20. However, if the power consumed by the electronic camera 10 is supplied in such a manner that only a significantly small amount of power is consumed rather than the normal activation mode, the power may be supplied to the other blocks.

In the electronic camera 10 of this embodiment, it is described that the CPU 20 controls almost all the functions of the electronic camera 10. However, it is possible to adopt the following configuration: there are a plurality of CPUs and functions controlled by each CPU differ from one another. The power-save mode state in such a configuration may be a state in which power is supplied only to the HDMI interface 36, the command controlling portion 24, and the CPU connected to the command controlling portion 24.

Moreover, in the electronic camera 10 of this embodiment, the command controlling portion 24 is connected to the HDMI interface 36, analyses the commands from the television receiver 4, and outputs instructions to the CPU 20. However, the CPU 20 may be provided with the functions of the command controlling portion 24. In such a case, the HDMI interface 36 and the CPU 20 are to be connected, and the command analysis is to be executed by the CPU 20.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An imaging apparatus provided with an imager for fetching an optical image of a subject so as to produce an image signal, comprising:
an interface portion for connecting an external electronic device controlled according to an instruction from a remote controller including a manipulation key and a main body of said imaging apparatus;
a command acceptor for accepting a command that is outputted from said external electronic device and that corresponds to an instruction in response to each manipulation of said manipulation key of said remote controller;
a reduced image signal producer for producing a reduced image signal corresponding to a reduced image of a still image or a moving image corresponding to the image signal, based on the image signal;
a storer for storing the image signal as an image file;
an output controller for executing an output process for outputting a plurality of the reduced image signals corresponding to a plurality of the image files stored in said storer, to said external electronic device via said interface portion; and
a controller for shifting one portion of the main body of said imaging apparatus to an activation state so as to execute the output process in said output controller, when a command corresponding to an instruction in response to a single manipulation of said manipulation key is accepted in said command acceptor in a case where the one portion of the main body of said imaging apparatus at least including said imager and said output controller is in a non-activation state.

2. An imaging apparatus according to claim 1, wherein said interface portion complies with an HDMI standard, and is provided with a mutual-device controlling function.

3. An imaging apparatus according to claim 1, wherein said external electronic device further comprises a displayer, the reduced image signal outputted by said output controller is a digital signal, and the digital signal outputted via said interface portion is supplied to said displayer.

4. A data communicating system for performing a data communication with an external electronic device that is connected to an imaging apparatus and that is controlled according to an instruction from a remote controller provided with a manipulation key, said imaging apparatus, comprising:
an imager for fetching an optical image of a subject so as to produce an image signal;
a reduced image signal producer for producing a reduced image signal corresponding to a reduced image of a still image or a moving image corresponding to the image signal, based on the image signal; and
a storer for storing the image signal as an image file,
said data communicating system, further comprising:
a command acceptor for accepting a command that is outputted from said external electronic device and that corresponds to an instruction in response to each manipulation of said manipulation key of said remote controller;
an output controller for executing an output process for outputting a plurality of the reduced image signals corresponding to a plurality of the image files stored in said storer, to said external electronic device; and
a controller for shifting one portion of the main body of said imaging apparatus to an activation state so as to execute the output process in said output controller, when a command corresponding to an instruction in response to a single manipulation of said manipulation key is accepted in said command acceptor in a case where the one portion of the main body of said imaging apparatus at least including said imager and said output controller is in a non-activation state.

5. A data communicating method for performing a data communication with an external electronic device that is connected to an imaging apparatus and that is controlled according to an instruction from a remote controller provided with a manipulation key, said imaging apparatus, including:
an imager for fetching an optical image of a subject so as to produce an image signal;
a reduced image signal producer for producing a reduced image signal corresponding to a reduced image of a still image or a moving image corresponding to the image signal, based on the image signal;
a storer for storing the image signal as an image file; and
an output controller for executing an output process for outputting via a plurality of the reduced image signals corresponding to a plurality of the image files stored in said storer, to said external electronic device,
said data communicating method, comprising:
a command accepting step of accepting a command that is outputted from said external electronic device and that corresponds to an instruction in response to each manipulation of said manipulation key of said remote controller;
a shifting step of shifting one portion of the main body of said imaging apparatus to an activation state so as to execute the output process in said output controller, when a command corresponding to the instruction in response to a single manipulation of said manipulation key is accepted in said command accepting step in a case where the one portion of the main body of said imaging apparatus at least including said imager and said output controller is in a non-activation state; and
a step for executing an output process in said output controller after said shifting step.
